(19) United States
(12) Patent Application Publication
(10) Pub. No.: US 2012/0301794 A1
(43) Pub. Date: Nov. 29, 2012

(54) COMPOSITE GEL ELECTROLYTE FILM FOR SECONDARY BATTERY, AND SECONDARY BATTERY

(75) Inventors: Meiten Koh, Settsu-shi (JP); Hideo Sakata, Settsu-shi (JP); Tomoyo Sanagi, Settsu-shi (JP); Hitomi Nakazawa, Settsu-shi (JP); Hiroyuki Arima, Settsu-shi (JP); Toshiki Ichisaka, Settsu-shi (JP)

(73) Assignee: DAIKIN INDUSTRIES, LTD., Osaka-shi, Osaka (JP)

(21) Appl. No.: 13/577,119

(22) PCT Filed: Feb. 7, 2011
(86) PCT No.: PCT/JP2011/052533

§ 371 Date: Aug. 3, 2012

(30) Foreign Application Priority Data
Feb. 5, 2010 (JP) 2010-024205

(51) Int. Cl. H01M 10/0565; H01M 10/0561

(52) U.S. Cl. 429/302; 429/303

(57) ABSTRACT

The present invention provides a composite gel electrolyte film for a secondary battery which has improved ion conductivity and excellent ignition resistance and is insusceptible to discoloration. The present invention is a composite gel electrolyte film for a secondary battery comprising: a gel electrolyte for a secondary battery formed of an electrolyte retention film impregnated with a nonaqueous electrolyte; and a porous film formed of at least one resin selected from the group consisting of polyethylene, polypropylene, and polyimide, the electrolyte retention film containing a vinylidene fluoride copolymer resin that includes a vinylidene fluoride unit and a tetrafluoroethylene unit at a molar ratio of 55/45 to 95/5 and further includes 0 to 10 mol % of a hexafluoropropylene unit, the total of the vinylidene fluoride unit, the tetrafluoroethylene unit, and the hexafluoropropylene unit being 100 mol %.

### TECHNICAL FIELD

The present invention relates to a composite gel electrolyte film for a secondary battery which has improved ion conductivity and excellent ignition resistance and is insusceptible to discoloration, and a secondary battery using the composite gel electrolyte film.

### BACKGROUND ART

Performance improvement of secondary batteries, especially of lithium secondary batteries, is strongly demanded because the secondary batteries take an important role in counteracting global warming, for example, in electric vehicles (EV).

The lithium secondary battery has a basic structure in which a nonaqueous electrolyte is positioned between a cathode and an anode, namely, the electrodes are positioned via a separator. The lithium secondary batteries are roughly classified into two types. One is a battery using an electrolyte solution prepared by dissolving an electrolyte in a solvent. The other is a battery using a solid electrolyte. Moreover, the batteries using electrolyte solutions are classified into two types. One is a battery enclosing an electrolyte solution as it is. The other is a battery enclosing a gel electrolyte in which an electrolyte solution is retained in a polymer gel film.

An electrolyte retention film forming a gel electrolyte is required to retain an electrolyte solution with safe and without deteriorating the electrical characteristics. In consideration of this, an electrolyte retention film is required to have high retention capacity of an electrolyte solution, high ion conductivity, thermal/chemical stability, and excellent mechanical strength.

To deal with such a demand, fluorine-free polyether resins have conventionally been used. However, in terms of the safety and ion conductivity, the fluorine-free polyether resins hardly meet the demand for performance improvement. Instead, use of fluoropolymers which are thermally and chemically stable has been considered (Patent Documents 1 to 11).

Patent Documents 1 and 2 each disclose an electrolyte retention film comprising a copolymer of vinylidene fluoride (VdF) and hexafluoropropylene (HFP). The VdF/HFP copolymer disclosed in these Patent Documents, however, heavily swells in an electrolyte solution especially at a high temperature, though it advantageously has high retention of the electrolyte solution. This may cause swelling of battery cells.

Patent Document 3 suggests use of a fluorine-based segmented polymer formed of a segment providing the film strength and a segment swelling in the electrolyte solution for the purpose of achieving both the retention of the electrolyte solution and the film strength.

Patent Document 4 proposes use of a VdF copolymer containing VdF (35 to 85 mol %), HFP (13 to 45 mol %), and tetrafluoroethylene (TFE) (0 to 35 mol %) for the purpose of achieving both the retention of the electrolyte solution and the film strength.

In addition, various proposals have been made, such as use of a polymer composition (polymer alloy) in which a VdF copolymer or polyvinylidene fluoride (PVdF) is mixed with polyoxyethylene (PEO) (Patent Documents 5, 6), use of a PVdF-PMVE copolymer to improve the film strength (Patent Document 7), use of PVdF having PEO or acrylate on its side chain (Patent Document 8) , and crosslinking of PVdF or a VdF/HFP copolymer to form a porous film (Patent Documents 9, 10). Moreover, Patent Document 11, which relates to a binder for a secondary battery and a battery electrode composition, teaches the utility of a copolymer of VdF and TFE as a polymer gel electrolyte but does not include any specific disclosure of the gel electrolyte or problems to be solved. In Patent Document 12 which relates to a polymer electrolyte secondary battery, a PVdF copolymer mainly formed of PVdF is listed as a polymer resin for a gel polymer electrolyte.

Patent Document 13 is aimed to provide a polymer electrolyte that is excellent in the film strength, thermal resistance, and the retention of the nonaqueous electrolyte and discloses a polymer electrolyte formed of a vinylidene copolymer impregnated with a nonaqueous electrolyte, wherein the vinylidene copolymer is formed of a repeating unit derived from VdF (35 to 99 mol %), a repeating unit derived from TFE (1 to 50 mol %), and a monomer copolymerizable with these (0 to 20 mol %) and has a melting point of not lower than 80° C. and a crystallinity of 20% to 80%. However, in Patent Document 13, a composite film formed of a polymer electrolyte and a porous film are not disclosed.

Patent Document 14 discloses a polymer film carrying an electrolyte solution. The polymer film comprises: a porous reinforcing member (A) formed of a highly thermal resistant resin with a thickness of not more than 100 μm; a VdF copolymer (B) formed of a repeating unit derived from VdF retained in the porous reinforcing member (50 to 99 mol %) and a repeating unit derived from TFE (1 to 50 mol %) with a melting point of not lower than 80° C. and a crystallinity of 20% to 80%; and an electrolyte solution (C) formed of a polar organic solvent (c1) integrated with the VdF copolymer to form a gel and an electrolyte (c2). Moreover, the polymer film has a thickness of not more than 200 μm, ion conductivity of not less than 0.05 S/m (25° C.), puncture strength of not less than 100 g, and a mechanical thermal resistance temperature of not lower than 200° C. In Patent Document 14, aromatic polyamide is used as the highly thermal resistant resin with an aim of providing a polymer film carrying an electrolyte solution for a lithium ion secondary battery that is highly safe under overcharge conditions with excellent ion conductivity, strength, and thermal resistance.

Patent Document 1: JP-T 08-507407

Patent Document 2: JP-A 09-022727

Patent Document 3: JP-A 11-067274

Patent Document 4: JP-A 11-162513

Patent Document 5: JP-A 09-097618

Patent Document 6: JP-A 08-315814

Patent Document 7: JP-A 2001-135353

Patent Document 8: JP-A 2002-117899

Patent Document 9: JP-A 2000-048639

Patent Document 10: JP-A 2001-023694

Patent Document 11: WO 98/27605

Patent Document 12: JP-A 11-354162

Patent Document 13: WO 99/28916

Patent Document 14: JP-A 2001-266942

### SUMMARY OF THE INVENTION

### Problems to be Solved by the Invention

Conventional separators are made of polyethylene, polypropylene, or the like, which are ignitable. In addition, if batteries are operated at a high voltage or high temperature, the cathode side thereof may be altered to be discolored.

The present invention is aimed to provide a composite gel electrolyte film for a secondary battery which has improved ion conductivity and excellent ignition resistance and is insusceptible to discoloration.

### Means to Solve the Problem

The present invention relates to a composite gel electrolyte film for a secondary battery comprising: a gel electrolyte for a secondary battery formed of an electrolyte retention film impregnated with a nonaqueous electrolyte; and a porous film formed of at least one resin selected from the group consisting of polyethylene, polypropylene, and polyimide, the electrolyte retention film containing a vinylidene fluoride copolymer resin that includes a vinylidene fluoride unit and a tetrafluoroethylene unit at a molar ratio of 55/45 to 95/5 and further includes 0 to 10 mol % of a hexafluoropropylene unit, the total of the vinylidene fluoride unit, the tetrafluoroethylene unit, and the hexafluoropropylene unit being 100 mol %.

The vinylidene fluoride copolymer resin is preferably a vinylidene fluoride binary copolymer resin formed only of the vinylidene fluoride unit and the tetrafluoroethylene unit.

The vinylidene fluoride copolymer resin is preferably a vinylidene fluoride ternary copolymer resin containing 1 to 5 mol % of the hexafluoropropylene unit.

The electrolyte retention film further preferably contains at least one of another resin other than the vinylidene fluoride copolymer resin according to claim 1 and rubber.

The another resin is preferably polyacrylonitrile, polyamide imide, polyvinylidene fluoride, a tetrafluoroethylene/hexafluoropropylene copolymer resin, or a mixed resin containing two or more of these.

The other rubber is preferably vinylidene fluoride/hexafluoropropylene copolymer rubber, vinylidene fluoride/tetrafluoroethylene/hexafluoropropylene copolymer rubber, acrylic rubber, or a mixed rubber containing two or more of these.

The amount of at least one of the another resin and the rubber is preferably not more than 400 parts by mass relative to 100 parts by mass of the vinylidene fluoride copolymer resin.

The electrolyte retention film preferably contains metal oxide particles.

The metal oxide particles are preferably aluminum oxide particles or silicon oxide particles.

The metal oxide particles preferably have an average particle size of not more than 20 μm.

The present invention also relates to a secondary battery comprising: the composite gel electrolyte film for a secondary battery; and electrodes.

### Effect of the Invention

The present invention provides a composite gel electrolyte film for a secondary battery which is excellent in the ion conductivity, ignition resistance, and discoloration resistance. The present invention also provides a secondary battery, especially a lithium secondary battery, comprising the composite gel electrolyte film for a secondary battery.

### MODES FOR CARRYING OUT THE INVENTION

The composite gel electrolyte film for a secondary battery of the present invention comprises a gel electrolyte for a secondary battery and a porous film.

The gel electrolyte for a secondary battery comprises an electrolyte retention film impregnated with a nonaqueous electrolyte, wherein the electrolyte retention film contains a specific VdF/TFE copolymer resin.

The electrolyte retention film used in the present invention contains a VdF/TFE copolymer resin that contains a VdF unit and a TFE unit at a molar ratio (VdF unit/TFE unit) of 55/45 to 95/5 and further contains 0 to 10 mol % of a HFP unit (the total of the VdF unit, TFE unit, and HFP unit is 100 mol %).

Examples of the VdF/TFE copolymer resin include a VdF/TFE binary copolymer and a VdF/TFE/HFP ternary copolymer.

In the case of the VdF/TFE binary copolymer, the molar ratio (VdF unit/TFE unit) is 55/45 to 95/5. If the molar ratio (VdF unit/TFE unit) is smaller than 55/45, such a copolymer is less likely to swell in an electrolyte solution and is less likely to be dissolved in a solvent, unfavorably causing a case where a film is hardly formed. The lower limit of the molar ratio (VdF unit/TFE unit) is 55/45 and more preferably 60/40 because such a molar ratio favorably realizes fine elongation characteristics and an appropriately low swelling rate in an electrolyte solution. The upper limit thereof is 95/5. The molar ratio exceeding the upper limit causes poor elongation characteristics and such a polymer is dissolved only in a high-boiling amide solvent such as N-methylpyrrolidone and dimethylformamide. Then, the degree of freedom in formation of a film is unfavorably narrowed. The upper limit of the molar ratio (VdF unit/TFE unit) is 95/5, more preferably 90/10, and particularly preferably 85/15.

In the case of the VdF/TFE/HFP ternary copolymer, the molar ratio (VdF unit/TFE unit) is 55/45 to 95/5 and not more than 10 mol % of a HFP unit is also contained. If the molar ratio (VdF unit/TFE unit) is smaller than 55/45, such a copolymer has a poor swelling rate in an electrolyte solution and poor solubility in a solvent. In such a case, unfavorably, a film is hardly formed. The lower limit of the molar ratio (VdF unit/TFE unit) is preferably 60/40 because such a molar ratio realizes fine elongation characteristics and an appropriately low swelling rate in an electrolyte solution. The upper limit thereof is 95/5. The molar ratio exceeding the upper limit causes poor elongation characteristics and such a polymer is dissolved only in a high-boiling amide solvent such as N-methylpyrrolidone and dimethylformamide. Then, the degree of freedom in formation of a film is unfavorably narrowed. More than 10 mol % of the HFP unit unfavorably increases the swelling rate in an electrolyte solution. The amount of the HFP unit is preferably not more than 5 mol % and more preferably not more than 4 mol %. The preferable lower limit of the HFP unit is 1 mol %.

With regard to the swelling rate in an electrolyte solution, a low swelling rate lowers the ion conductivity. On the other hand, a high swelling rate increases the ion conductivity but also increases swelling of the gel electrolyte, resulting in a swelled battery cell. Accordingly, an appropriate swelling rate is preferably as low as possible while maintaining the ion conductivity. A gel electrolyte polymer preferably has a low swelling rate and high ion conductivity. Here, it is to be noted that the ion conductivity is not determined only by the swelling rate but also by the crystallinity of the polymer. For example, in comparison with PVdF, some TFE/VdF/HFP copolymers have higher ion conductivity despite a lower swelling rate owing to their low crystallinity.

The VdF/TFE copolymer resin preferably has a melting point of 100° C. to 200° C. The melting point is determined as a temperature corresponding to the maximum value of a melting heat curve that is obtained using a differential scanning calorimeter (DSC) under the condition that the temperature is raised at a rate of 10° C./min.

In the present invention, the electrolyte retention film may further contain another resin or rubber, in addition to the VdF/TFE copolymer resin, with an aim of improving the ion conductivity and the tensile strength while maintaining the improved elongation. In the present description, the word “resin” refers to a material having a melting point of not lower than the room temperature (e.g. 25° C.) and the word “rubber” refers to a material not having a definite melting point at a temperature not lower than the room temperature.

Preferable examples of the another resin to be used together with the VdF/TFE copolymer resin include polyacrylonitrile, polyamideimide, polyvinylidene fluoride (PVdF), and a VdF/HFP copolymer resin, and one or two or more of them may be used. Preferable examples of the rubber to be used together include VdF/HFP copolymer rubber, VdF/TFE/HFP copolymer rubber, and acrylic rubber, and one or two or more of them may be used. These rubbers may or may not be crosslinked.

Particularly preferable examples of the another resin or rubber to be used together include: acrylic rubber from the standpoint of improvement in the ion conductivity; and VdF/HFP copolymer rubber, VdF/TFE/HFP copolymer rubber, and a VdF/HFP resin from the standpoint of improvement in the ion conductivity and oxidation resistance.

The VdF/HFP copolymer rubber preferably has a molar ratio (VdF unit/HFP unit) of 80/20 to 65/35.

The VdF/TFE/HFP copolymer rubber preferably has a molar ratio (VdF unit/TFE unit/HFP unit) of 80/5/15 to 60/30/10.

The VdF/HFP resin preferably has a molar ratio (VdF unit/HFP unit) of 98/2 to 85/15.

The VdF/HFP resin preferably has a melting point of 100° C. to 200° C.

The amount of the another resin or rubber is preferably not more than 400 parts by mass, more preferably not more than 200 parts by mass, and still more preferably not more than 150 parts by mass for 100 parts by mass of the specific VdF/TFE copolymer resin. The lower limit depends on the target effect and is around 10 parts by mass.

The electrolyte retention film may contain metal oxide particles. The metal oxide particles are not particularly limited, and are preferably other than oxide particles of alkali metals or alkali earth metals from the standpoint of improvement in the ion conductivity and shutdown effect. Especially preferable are aluminum oxide, silicon oxide, titanium oxide, vanadium oxide, and copper oxide. The particles preferably have an average particle size of not more than 20 μm and more preferably not more than 10 μm. In particular, the particles are preferably fine particles having an average particle size of not more than 5 μm.

Particularly preferable metal oxide particles are aluminum oxide particles or silicon oxide particles having an average particle size of not more than 5 μm because such particles have excellent ion conductivity.

The method for producing an electrolyte retention film is not particularly limited, and a conventionally known method may be employed. Specifically, an exemplary method includes the steps of: dissolving a VdF/TFE copolymer in a solvent; casting the solution on a film having a smooth surface, such as a polyester film and an aluminum film; and peeling the formed film. Alternatively, the solution may be directly applied to electrodes.

Examples of the solvent include: amide solvents such as N-methyl-2-pyrrolidone, dimethylformamide, and dimethylacetamide; ketone solvents such as methyl isobutyl ketone, methyl ethyl ketone, and cyclohexanone; and cyclic ether solvents such as tetrahydrofuran and methyltetrahydrofuran. Though PVdF is soluble only in a high boiling and highly polar amide solvents, a VdF/TFE copolymer is soluble in lower boiling and less polar cyclic ketones or ethers. Accordingly, a solvent to be used preferably has a comparatively low melting point and a comparatively low polarity.

The electrolyte retention film may have a common thickness of around 5 to 50 μm.

The electrolyte retention film may be used alone.

The composite gel electrolyte film for a secondary battery of the present invention is produced by complexing the electrolyte retention film and a porous film.

The porous film is a resin film comprising at least one resin selected from the group consisting of polyethylene, polypropylene, and polyimide. The total weight of polyethylene, polypropylene, and polyimide in the porous film is preferably not less than 50% by mass. The porous film is more preferably formed of polyethylene. The porous film may be further formed of polyamide, polyamide imide, and the like.

The porous film is preferably a porous film obtainable by casting polyethylene, polypropylene, polyimide, and if needed, polyamide and polyamide imide onto an unwoven fabric; or a porous film obtainable by filming a mixture of these synthetic resins and a water-soluble inorganic oxide and then washing the film to remove the inorganic oxide. Such a film allows easy permeation of an electrolyte solution thereinto to increase the ion conductivity, and thus is preferable.

Preferable complexing methods include a method of applying a VdF/TFE copolymer solution to a porous film by roll coating, and a method of dipping a porous film in a VdF/TFE copolymer solution. Alternatively, an electrolyte retention film and a porous film may be stacked by a lamination technique or the like.

The composite gel electrolyte film for a secondary battery preferably has a configuration in which a conventional separator is coated with an electrolyte retention film layer formed by application of or dipping in the gel electrolyte polymer solution of the present invention. The conventional separator formed of polyethylene, polypropylene, or polyimide is ignitable. In addition, if batteries are operated at a high voltage or high temperature, the cathode side thereof may be altered to be discolored. Here, formation of an electrolyte retention film layer on the separator reduces ignitability. In addition, application of the electrolyte solution on the cathode side avoids discoloration of the separator at a high voltage or high temperature.

The nonaqueous electrolyte with which the electrolyte retention film is impregnated may be a known electrolyte salt dissolved in a known organic solvent for dissolving an electrolyte.

The organic solvent for dissolving an electrolyte is not particularly limited, and examples thereof include known hydrocarbon solvents such as propylene carbonate, ethylene carbonate, butylene carbonate, γ-butyrolactone, 1,2-dimethoxyethane, 1,2-diethoxyethane, dimethyl carbonate, and diethyl carbonate; and fluorine solvents such as fluoroethylene carbonate, fluoroether, and fluorinated carbonate. Among these, one or two or more kinds of solvents may be used.

Examples of the electrolyte salt for a lithium secondary battery include LiClO₄, LiAsF₆, LiBF₄, LiPF₆, LiN(SO₂CF₃)₂, and LiN(SO₂C₂F₅)₂. In particular, LiPF₆, LiBF₄, LiN(SO₂CF₃)₂, LiN(SO₂C₂F₅)₂, or a combination of these is preferable because cycling characteristics are favorable.

The concentration of the electrolyte salt is required to be not less than 0.8 mol/litter, and preferably not less than 1.0 mol/litter. Though it depends on the organic solvent for dissolving an electrolyte salt, the upper limit thereof is commonly 1.5 mol/litter.

The secondary battery of the present invention is produced by putting a cathode, an anode, and the gel electrolyte of the present invention in a battery casing and then sealing the battery casing. In the case of producing a lithium secondary battery, a known active material for a lithium secondary battery may be used as a cathode and an anode. A separator may be positioned between the cathode and the anode.

### EXAMPLES

The present invention is described with reference to, but not limited to, synthesis examples, examples, and comparative examples.

### Reference Example 1

A TFE/VdF/HFP (38/60/2 in mol % ratio) copolymer was dissolved in tetrahydrofuran (THF). The resulting solution was applied onto a polyester (PET) film and dried at 100° C. for 15 minutes. The dried matter was peeled to give an electrolyte retention film (electrolyte retention film 1) having a thickness of 30 μm. The melting point of the polymer was 140° C.

A dumbbell specimen (5 cm×3 cm rectangle piece) was cut out from the electrolyte retention film 1. Using a tensile tester (RTC-1225A, Orientec Co., Ltd.), the tensile strength at break of the specimen was determined. Table 1 shows the results.

The swelling rate in electrolyte solution, ion conductivity, and ignitability of the obtained electrolyte retention film 1 were determined by the following methods. Table 1 shows the results.

### (Swelling Rate in Electrolyte Solution)

A sample (5×20 mm) was cut out from the electrolyte retention film and then placed in a sample bottle containing an electrolyte solution (1 M solution of LiPF₆ dissolved in a solvent containing ethylene carbonate and ethyl methyl carbonate at a volume ratio of 3/7). The film was allowed to standstill at 90° C. for two days. Then, the mass increase (%) compared to the mass before placement in the bottle was calculated.

### (Ion Conductivity)

The electrolyte retention film was immersed in an electrolyte solution (1 M solution of LiPF₆ dissolved in a solvent containing ethylene carbonate and ethyl methyl carbonate at a volume ratio of 3/7) for 10 minutes. The film was then sandwiched between SUS electrodes and connected to a galvano-potentiostat (Frequency response analyzer: 1260 type, Solartron, Potensiostat: 1287 type, Solartron). The ion conductivity (S/cm) was determined by an alternating current impedance method (frequency: 10⁻³ to 10⁶ Hz, AC voltage: 10 mV).

### (Ignitability)

The electrolyte retention film was immersed in an electrolyte solution (1 M solution of LiPF₆ dissolved in a solvent containing ethylene carbonate and ethyl methyl carbonate at a volume ratio of 3/7) for 10 minutes. Then, the film was roasted over an alcohol lamp and whether it ignites was checked.

Next, a lithium secondary battery was produced using the obtained electrolyte retention film by the following method. Discoloration of the battery during the operations at a high temperature and at a high voltage was checked. Table 1 shows the results.

### (Production of Lithium Secondary Battery)

### <Production of Cathode>

A cathode active material containing Li₂Mn₂O₄, carbon black, and polyvinylidene fluoride (trade name: KF-1000, KUREHA CORPORATION) at a ratio of 94/3/3 (% by mass) was dispersed in N-methyl-2-pyrrolidone to form slurry. The slurry was uniformly applied onto a cathode collector (aluminum foil having a thickness of 20 μm) and dried to provide a cathode. The cathode was used in a high temperature test. As a cathode to be used in a high voltage test, a cathode was produced in the same manner as above except that the cathode active material was changed to LiNi_{0.5}Mn_{1.5}O₄.

### <Production of Anode>

Styrene-butadiene rubber dispersed in distilled water was added to artificial graphite powder (trade name: MAG-D, Hitachi Chemical Co., Ltd.) such that the solid content was 6% by mass and then mixed with a disperser to form slurry. The slurry was uniformly applied onto an anode collector (aluminum foil having a thickness of 18 μm) and dried to produce an anode.

The cathode and the anode were each cut into a rectangle (50 mm×100 mm). The electrolyte retention film 1 was sandwiched between the cathode and the anode as a separator to form a laminate. Then, aluminum foil (5 mm in width and 150 mm in length) was welded to the cathode and the anode as leads. The resulting laminate was immersed in the electrolyte solution (1 M solution of LiPF₆ dissolved in a solvent containing ethylene carbonate (EC) and ethyl methyl carbonate (EMC) at a volume ratio of 3/7) and sealed using a laminator to provide a laminate-type lithium secondary battery.

### <High Temperature Test>

The electrolyte retention film was held at 60° C. under the following charge and discharge conditions. After 50 cycles of charge and discharge, presence of discoloration of the electrolyte retention film was checked.

Charge and discharge voltage: 2.5 to 4.2 V
Charge: A steady voltage was held at 0.5 C and 4.2 V until the charge current was reduced to 1/10.

### Discharge: 0.5 C

### <High Voltage Test>

The electrolyte retention film was held under the following charge and discharge conditions. After 50 cycles of charge and discharge, presence of discoloration of the electrolyte retention film was checked.

Charge and discharge voltage: 2.5 to 4.9 V
Charge: A steady voltage was held at 0.5 C and 4.9 V until the charge current was reduced to 1/10.

### Discharge: 0.5 C

### Reference Example 2

The tensile strength at break, swelling rate in electrolyte solution, ion conductivity, ignitability, discoloration in operation at a high temperature, and discoloration in operation at a high voltage were checked in the same manner as in Reference Example 1, except that an electrolyte retention film 2 produced by the following method was used. Table 1 shows the results.

### (Production of Electrolyte Retention Film 2)

A TFE/VdF (20/80 in mol % ratio) copolymer was dissolved in methyl isobutyl ketone. The solution was applied onto a PET film and dried at 100° C. for 15 minutes. The dried matter was peeled to give an electrolyte retention film 2 having a thickness of 30 μm. The melting point of the polymer was 120° C.

### Comparative Example 1

The tensile strength at break, swelling rate in electrolyte solution, ion conductivity, ignitability, discoloration in operation at a high temperature, and discoloration in operation at a high voltage were checked in the same manner as in Reference Example 1, except that an electrolyte retention film 1 for comparison produced by the following method was used. Table 1 shows the results.

### (Production of Electrolyte Retention Film 1 for Comparison)

PVdF was dissolved in N-methyl-2-pyrrolidone (NMP). The solution was applied onto a PET film and dried at 100° C. for 30 minutes. The dried matter was peeled to give an electrolyte retention film 1 for comparison having a thickness of 30 μm.

### Comparative Example 2

The tensile strength at break, swelling rate in electrolyte solution, ion conductivity, ignitability, discoloration in operation at a high temperature, and discoloration in operation at a high voltage were checked in the same manner as in Reference Example 1, except that an electrolyte retention film 2 for comparison produced by the following method was used. Table 1 shows the results.

### (Production of Electrolyte Retention Film 2 for Comparison)

A VdF/HFP (88/12 in mol % ratio) copolymer was dissolved in NMP. The solution was applied onto a PET film and dried at 100° C. for 30 minutes. The dried matter was peeled to give an electrolyte retention film 2 for comparison having a thickness of 30 μm.

TABLE 1

| | Reference Example | | Comparative Example | |
|---|---|---|---|---|
| Electrolyte retention film | 1 | 2 | 1 | 2 |
| TFE/VdF/HFP (38/60/2 in mol % ratio) (parts by mass) | 100 | — | — | — |
| TFE/VdF (20/80 in mol % ratio) (parts by mass) | — | 100 | — | — |
| PVdF (parts by mass) | — | — | 100 | — |
| VdF/HFP (88/12 in mol % ratio) (parts by mass) | — | — | — | 100 |
| Tensile strength at break (%) | 520 | 450 | 60 | 230 |
| Swelling rate in electrolyte solution (%) | 7 | 18 | 15 | 48 |
| Ion conductivity (S/cm) (×10⁻⁴) | 6 | 5 | 0.5 | 3 |
| Ignitability | Not ignitable | Not ignitable | Not ignitable | Not ignitable |
| Discoloration in operation at a high temperature | Not present | Not present | Not present | Not present |
| Discoloration in operation at a high voltage | Not present | Not present | Not present | Not present |

Table 1 shows that the TFE/VdF copolymer and the TFE/VdF/HFP copolymer stretch better than PVdF and the VdF/HFP copolymer so as to have higher ion conductivity even with a low swelling rate.

### Reference Examples 3 to 10

The tensile strength at break, swelling rate in electrolyte solution, ion conductivity, ignitability, discoloration in operation at a high temperature, and discoloration in operation at a high voltage were checked in the same manner as in Reference Example 1, except that electrolyte retention films 3 to 10 produced by the following methods were used. Table 2 shows the results.

### (Production of Electrolyte Retention Film 3)

A TFE/VdF/HFP (38/60/2 in mol % ratio) copolymer and TFE/VdF/HFP (6/77/17 in mol % ratio) copolymer rubber were blended together at a mass ratio of 75/25. The blend was dissolved in THF. The solution was applied onto a PET film and dried at 100° C. for 15 minutes. The dried matter was peeled to give an electrolyte retention film 3 having a thickness of 30 μm. The definite melting point of the copolymer rubber was not observed at a temperature not lower than ambient temperatures.

### (Production of Electrolyte Retention Film 4)

A TFE/VdF/HFP (38/60/2 in mol % ratio) copolymer and TFE/VdF/HFP (6/77/17 in mol % ratio) copolymer rubber were blended together at a mass ratio of 50/50. The blend was dissolved in THF. The solution was applied onto a PET film and dried at 100° C. for 15 minutes. The dried matter was peeled to give an electrolyte retention film 4 having a thickness of 30 μm. The definite melting point of the copolymer rubber was not observed at a temperature not lower than ambient temperatures.

### (Production of Electrolyte Retention Film 5)

A TFE/VdF/HFP (38/60/2 in mol % ratio) copolymer and VdF/HFP (78/22 in mol % ratio) copolymer rubber were blended together at a mass ratio of 75/25. The blend was dissolved in THF. The solution was applied onto a PET film and dried at 100° C. for 15 minutes. The dried matter was peeled to give an electrolyte retention film 5 having a thickness of 30 μm. The definite melting point of the copolymer rubber was not observed at a temperature not lower than ambient temperatures.

### (Production of Electrolyte Retention Film 6)

A TFE/VdF/HFP (38/60/2 in mol % ratio) copolymer and VdF/HFP (78/22 in mol % ratio) copolymer rubber were blended together at a mass ratio of 50/50. The blend was dissolved in THF. The solution was applied onto a PET film and dried at 100° C. for 15 minutes. The dried matter was peeled to give an electrolyte retention film 6 having a thickness of 30 μm. The definite melting point of the copolymer rubber was not observed at a temperature not lower than ambient temperatures.

### (Production of Electrolyte Retention Film 7)

A TFE/VdF/HFP (38/60/2 in mol % ratio) copolymer and acrylic rubber particles (W-450A, MITSUBISHI RAYON CO., LTD.) were blended together at a mass ratio of 80/20. The blend was dissolved in THF. The solution was applied onto a PET film and dried at 100° C. for 15 minutes. The dried matter was peeled to give an electrolyte retention film 7 having a thickness of 30 μm.

### (Production of Electrolyte Retention Film 8)

A TFE/VdF/HFP (38/60/2 in mol % ratio) copolymer and polyacrylonitrile particles (Aldrich) were blended together at amass ratio of 80/20. The blend was dissolved in THF. The solution was applied onto a PET film and dried at 100° C. for 15 minutes. The dried matter was peeled to give an electrolyte retention film 8 having a thickness of 30 μm.

### (Production of Electrolyte Retention Film 9)

A TFE/VdF/HFP (38/60/2 in mol % ratio) copolymer and SiO₂ particles (SP03F, FUSO CHEMICAL CO., LTD., particle size of about 0.3 μm) were blended together at a mass ratio of 90/10. The blend was dissolved in THF. The solution was applied onto a PET film and dried at 100° C. for 15 minutes. The dried matter was peeled to give an electrolyte retention film 9 having a thickness of 30 μm.

### (Production of Electrolyte Retention Film 10)

A TFE/VdF/HFP (38/60/2 in mol% ratio) copolymer and Al₂O₃ particles (AX3-15, MICRON CO., particle size of about 0.3 μm) were blended together at a mass ratio of 90/10. The blend was dissolved in THF. The solution was applied onto a PET film and dried at 100° C. for 15 minutes. The dried matter was peeled to give an electrolyte retention film 10 having a thickness of 30 μm.

TABLE 2

| | Reference Example | | | | | | | |
|---|---|---|---|---|---|---|---|---|
| | 3 | 4 | 5 | 6 | 7 | 8 | 9 | 10 |
| Electrolyte retention film | | | | | | | | |
| TFE/VdF/HFP (38/60/2 in mol % | 75 | 50 | 75 | 50 | 80 | 80 | 90 | 90 |
| ratio) (parts by mass) | | | | | | | | |
| TFE/VdF/HFP (6/77/17 in mol % | 25 | 50 | — | — | — | — | — | — |
| ratio) (parts by mass) | | | | | | | | |
| VdF/HFP (78/22 in mol % | — | — | 25 | 50 | — | — | — | — |
| ratio) (parts by mass) | | | | | | | | |
| Acrylic rubber particles | — | — | — | — | 20 | — | — | — |
| (parts by mass) | | | | | | | | |
| Polyacrylointrile (parts by mass) | — | — | — | — | — | 20 | — | — |
| SiO₂ particles (parts by mass) | — | — | — | — | — | — | 10 | — |
| Al₂O₃ particles (parts by mass) | — | — | — | — | — | — | — | 10 |
| Tensile strength at break (%) | 510 | 530 | 310 | 260 | 480 | 340 | 310 | 270 |
| Swelling rate in electrolyte | 11 | 14 | 21 | 27 | 11 | 9 | 7 | 7 |
| solution (%) | | | | | | | | |
| Ion conductivity (S/cm) (×10⁻⁴) | 20 | 40 | 7 | 7 | 10 | 10 | 8 | 7 |
| Ignitability | Not ignitable | Not ignitable | Not ignitable | Not ignitable | Not ignitable | Not ignitable | Not ignitable | Not ignitable |
| Discoloration in operation at a | Not present | Not present | Not present | Not present | Not present | Not present | Not present | Not present |
| high temperature | | | | | | | | |
| Discoloration in operation at a | Not present | Not present | Not present | Not present | Not present | Not present | Not present | Not present |
| high voltage | | | | | | | | |

Table 2 shows the following facts that blending of the TFE/VdF copolymer resins having different compositions maintains the stretch properties and adjusts the swelling rate so that high ion conductivity is kept. Further, the resin does not have ignitability and are not suffered from discoloration in operation at a high temperature/voltage. Moreover, complexing with acrylic fine particles/acrylonitrile, silica/alumina, or the like enables to increase the ion conductivity.

### Examples 1 to 6

The ion conductivity, ignitability, discoloration in operation at a high temperature, and discoloration in operation at a high voltage were checked in the same manner as in Reference Example 1, except that electrolyte retention film-coated separators 1 to 6 produced by the following methods were used instead of the electrolyte retention film. Table 3 shows the results.

### (Production of Electrolyte Retention Film-Coated Separator 1)

A TFE/VdF/HFP (38/60/2 in mol % ratio) copolymer was dissolved in THF. The solution was applied onto a polyethylene separator (22 μm in thick) and dried at 80° C. for 15 minutes to provide a separator 1 coated with an electrolyte retention film layer (1 μm in thick) (mass ratio of separator: the VdF/TFE copolymers in electrolyte retention film layer =about 1:0.5).

### (Production of Electrolyte Retention Film-Coated Separator 2)

A TFE/VdF/HFP (38/60/2 in mol % ratio) copolymer and TFE/VdF/HFP (6/77/17 in mol % ratio) copolymer rubber were blended at a mass ratio of 75/25. The blend was dissolved in THF. The solution was applied onto a polyethylene separator (22 μm in thick) and dried at 80° C. for 15 minutes to provide a separator 2 (23 μm in thick) coated with an electrolyte retention film layer (mass ratio of separator:the VdF/TFE copolymers in electrolyte retention film layer=about 1:0.5).

### (Production of Electrolyte Retention Film-Coated Separator 3)

A TFE/VdF/HFP (38/60/2 in mol % ratio) copolymer and TFE/VdF/HFP (6/77/17 in mol % ratio) copolymer rubber were blended at a mass ratio of 50/50. The blend was dissolved in THF. The solution was applied onto a polyethylene separator (22 μm in thick) and dried at 80° C. for 15 minutes to provide a separator 3 coated with an electrolyte retention film layer (1 μm in thick) (mass ratio of separator:the VdF/TFE copolymers in electrolyte retention film layer =about 1:0.5).

### (Production of Electrolyte Retention Film-Coated Separator 4)

A TFE/VdF/HFP (38/60/2 in mol % ratio) copolymer and acrylic rubber particles (W-450A, MITSUBISHI RAYON CO., LTD.) were blended together at a mass ratio of 80/20. The blend was dissolved in THF. The solution was applied onto a polyethylene separator (22 μm in thick) and dried at 80° C. for 15 minutes to provide a separator 4 coated with an electrolyte retention film layer (1 μm in thick) (mass ratio of separator:the VdF/TFE copolymers in electrolyte retention film layer =about 1:0.5).

### (Production of Electrolyte Retention Film-Coated Separator 5)

A TFE/VdF/HFP (38/60/2 in mol % ratio) copolymer and TFE/VdF/HFP (6/77/17 in mol % ratio) copolymer rubber were blended at a mass ratio of 50/50. Then, Al₂O₃ particles (AX3-15, MICRON CO., particle size of about 0.3 μm) were further blended therewith such that the amount of the Al₂O₃ particles is 10% by mass relative to the amount of the blend. The resulting blend was dissolved in THF. The solution was applied onto a polyethylene separator (22 μm in thick) and dried at 80° C. for 15 minutes to provide a separator 5 coated with an electrolyte retention film layer (1 μm in thick) (mass ratio of separator:the VdF/TFE copolymers in electrolyte retention film layer=about 1:0.5).

### (Production of Electrolyte Retention Film-Coated Separator 6)

A TFE/VdF/HFP (38/60/2 in mol % ratio) copolymer and TFE/VdF/HFP (6/77/17 in mol % ratio) copolymer rubber were blended at a mass ratio of 25/75. The blend was dissolved in THF. The solution was applied onto a polyethylene separator (22 μm in thick) and dried at 80° C. for 15 minutes to provide a separator 3 coated with an electrolyte retention film layer (1 μm in thick) (mass ratio of separator:the VdF/TFE copolymers in electrolyte retention film layer=about 1:0.5).

### Comparative Example 3

The ion conductivity, ignitability, discoloration in operation at a high temperature, and discoloration in operation at a high voltage were checked in the same manner as in Example 1, except that a polyethylene separator (22 μm in thick) not coated with an electrolyte retention film layer was used. Table 3 shows the results.

TABLE 3

| | | | | | | | Comparative |
|---|---|---|---|---|---|---|---|
| | Example | | | | | | Example |
| | 1 | 2 | 3 | 4 | 5 | 6 | 3 |
| Electrolyte retention film | | | | | | | |
| TFE/VdF/HFP (38/60/2 in mol % ratio) | 100 | 75 | 50 | 80 | 50 | 25 | — |
| (parts by mass) | | | | | | | |
| TFE/VdF/HFP (6/77/17 in mol % ratio) | — | 25 | 50 | — | 50 | 75 | — |
| (parts by mass) | | | | | | | |
| VdF/HFP (78/22 in mol % ratio) (parts by mass) | — | — | — | — | — | — | — |
| Acrylic rubber particles (parts by mass) | — | — | — | 20 | — | — | — |
| Al₂O₃ particles (parts by mass) | — | — | — | — | 10 | — | — |
| Ion conductivity (S/cm) (×10⁻⁴) | 4 | 8 | 30 | 8 | 5 | 38 | 30 |
| Ignitability | Not ignitable | Not ignitable | Not ignitable | Not ignitable | Not ignitable | Not ignitable | Ignitable |
| Discoloration in operation at a high temperature | Not present | Not present | Not present | Not present | Not present | Not present | Present |
| Discoloration in operation at a high voltage | Not present | Not present | Not present | Not present | Not present | Not present | Present |

Table 3 shows that application of a gel electrolyte onto a separator prevents ignitability and discoloration in operation at a high temperature/voltage. Moreover, Table 3 also shows that selection of an appropriate polymer leads to higher ion conductivity.

### Example 7

A TFE/VdF/HFP (38/60/2 in mol % ratio) copolymer and TFE/VdF/HFP (6/77/17 in mol % ratio) copolymer rubber were blended at a mass ratio of 50/50. The blend was dissolved in THF. The solution was applied onto the cathode produced in Reference Example 1 and dried at 80° C. for 15 minutes to provide a cathode coated with a 2 μm-thick electrolyte retention film layer. A laminate cell was produced in the same manner as in Reference Example 1, except that the electrolyte retention film-coated cathode was used and a polyethylene separator (22 μm in thick) was used. The high temperature/voltage tests were conducted thereto and no discoloration was found in the cathode.

### Example 8

A laminate cell was produced in the same manner as in Reference Example 1, except that the electrolyte solution was prepared by dissolving LiPF₆ into EC/dimethylcarbonate (DMC)/EMC/HCF₂CF₂CH₂OCF₂CF₂H (20/50/10/20 in volume ratio) at 1 M concentration and adding vinylene carbonate (VC) (0.1% by mass) and fluoroethylene carbonate (FEC) (3% by mass) thereto as additives, and that the electrolyte retention film-coated separator 3 was used. The high temperature test was carried out under the following conditions so that discoloration of the separator and the volume maintenance ratio were determined. Table 4 shows the results.

### <High Temperature Test>

The electrolyte retention film was held at 60° C. under the following charge and discharge conditions. After 100 cycles of charge and discharge, presence of discoloration of the electrolyte retention film and the volume maintenance ratio in comparison with that after 5 cycles of charge and discharge was checked.

Charge and discharge voltage: 2.5 to 4.3 V
Charge: A steady voltage was held at 0.5 C and 4.3 V until the charge current was reduced to 1/10.

### Discharge: 0.5 C

### Comparative Example 4

A laminate cell was produced in the same manner as in Example 8, except that the electrolyte solution was prepared by dissolving LiPF₆ into EC/DMC/EMC/HCF₂CF₂CH₂OCF₂CF₂H (20/50/10/20 in volume ratio) at 1 M concentration and adding vinylene carbonate (VC) (0.1% by mass) and fluoroethylene carbonate (FEC) (3% by mass) thereto as additives, and that a polyethylene separator not coated with an electrolyte retention film was used. The high temperature test of Example 8 was carried out so that discoloration of the separator and the volume maintenance ratio were determined. Table 4 shows the results.

### Example 9

A laminate cell comprising the electrolyte retention film-coated separator 3 was produced in the same manner as in Example 8, except that the electrolyte solution was prepared by dissolving LiPF₆ into EC/EMC (30/70 in volume ratio) at 1 M concentration. The high temperature test of Example 8 was carried out so that discoloration of the separator and the volume maintenance ratio were determined. Table 4 shows the results.

### Comparative Example 5

A laminate cell was produced in the same manner as in Example 9, except that a polyethylene separator not coated with an electrolyte retention film was used. The high temperature test of Example 8 was carried out so that discoloration of the separator and the volume maintenance ratio were determined.

Table 4 shows the results.

### Example 10

A laminate cell was produced in the same manner as in Example 8, except that the electrolyte retention film-coated separator 6 was used. The high temperature test of Example 8 was carried out so that discoloration of the separator and the volume maintenance ratio were determined. Table 4 shows the results.

TABLE 4

| | | Comparative | | Comparative | |
|---|---|---|---|---|---|
| | Example 8 | Example 4 | Example 9 | Example 5 | Example 10 |
| Electrolyte | 1M LiPF₆ | 1M LiPF₆ | 1M LiPF₆ | 1M LiPF₆ | 1M LiPF₆ |
| solution | EC/DMC/EMC/HCF₂ | EC/DMC/EMC/HCF₂ | EC/EMC (3/7) | EC/EMC (3/7) | EC/DMC/EMC/HCF₂ |
| | CF₂CH₂OCF₂CG₂H + | CF₂CH₂OCF₂CG₂H + | | | CF₂CH₂OCF₂CG₂H + |
| | VC 0.1% + FEC 3% | VC 0.1% + FEC 3% | | | VC 0.1% + FEC 3% |
| Separator | Electrolyte retention | Polyethylene separator | Electrolyte retention | Polyethylene | Electrolyte retention |
| | film-coated separator 3 | | film-coated separator 3 | separator | film-coated separator 6 |
| Presence of | Not present | Present | Not present | Present | Not present |
| discoloration | | | | | |
| Volume maintenance | 87 | 80 | 65 | 54 | 88 |
| ratio (%) | | | | | |

Table 4 shows that use of a cathode applied with a gel electrolyte leads to no discoloration and better volume maintenance ratio compared to those of a common separator even when an electrolyte solution is changed.

1. A composite gel electrolyte film for a secondary battery comprising:
a gel electrolyte for a secondary battery formed of an electrolyte retention film impregnated with a nonaqueous electrolyte; and
a porous film formed of at least one resin selected from the group consisting of polyethylene, polypropylene, and polyimide,
the electrolyte retention film containing a vinylidene fluoride binary copolymer resin formed only of a vinylidene fluoride unit and a tetrafluoroethylene unit at a molar ratio of 55/45 to 90/10.

2-3. (canceled)

4. The composite gel electrolyte film for a secondary battery according to claim 1,
wherein the electrolyte retention film further contains at least one of another resin other than the vinylidene fluoride copolymer resin according to claim 1 and rubber.

5. The composite gel electrolyte film for a secondary battery according to claim 4,
wherein the another resin is polyacrylonitrile, polyamide imide, polyvinylidene fluoride, a tetrafluoroethylene/hexafluoropropylene copolymer resin, or a mixed resin containing two or more of these.

6. The composite gel electrolyte film for a secondary battery according to claim 4,
wherein the rubber is vinylidene fluoride/hexafluoropropylene copolymer rubber, vinylidene fluoride/tetrafluoroethylene/hexafluoropropylene copolymer rubber, acrylic rubber, or a mixed rubber containing two or more of these.

7. The composite gel electrolyte film for a secondary battery according to claim 4,
wherein the amount of at least one of the another resin and the rubber is not more than 400 parts by mass relative to 100 parts by mass of the vinylidene fluoride copolymer resin.

8. The composite gel electrolyte film for a secondary battery according to claim 1,
wherein the electrolyte retention film contains metal oxide particles.

9. The composite gel electrolyte film for a secondary battery according to claim 8,
wherein the metal oxide particles are aluminum oxide particles or silicon oxide particles.

10. The composite gel electrolyte film for a secondary battery according to claim 8,
wherein the metal oxide particles have an average particle size of not more than 20 μm.

11. A secondary battery comprising:
the composite gel electrolyte film for a secondary battery according to claim 1; and electrodes.
